(19) United States
(12) Patent Application Publication
(10) Pub. No.: US 2017/0068458 A1
(43) Pub. Date: Mar. 9, 2017

(54) HARDWARE-ACCELERATED STORAGE COMPRESSION

(71) Applicant: QUALCOMM Incorporated, San Diego, CA (US)

(72) Inventors: Hyunsuk Shin, San Diego, CA (US); Jung Pill Kim, San Diego, CA (US)

(21) Appl. No.: 14/844,443

(22) Filed: Sep. 3, 2015

(51) Int. Cl. G06F 3/06

(52) U.S. Cl. CPC G06F 3/0608; G06F 3/0685; G06F 3/064; G06F 3/0644; G06F 3/0665

(57) ABSTRACT

Hardware-accelerated storage compression is disclosed. In one aspect, prior to writing an uncompressed data block to a storage device, a hardware compression accelerator provided in a storage controller compresses the uncompressed data block into a compressed data block and allocates the compressed data block to a physical data block in the storage device. The hardware compression accelerator then generates a modified logical block address (LBA) to link the uncompressed data block to the compressed data block. In another aspect, the hardware compression accelerator locates a compressed data block based on a corresponding modified LBA and decompresses the compressed data block into an uncompressed data block. By performing hardware-accelerated storage compression in the storage controller, it is possible to reduce processing overhead associated with conventional software-based compression systems and improve compression control over conventional storage-device-driven compression systems.

### BACKGROUND

I. Field of the Disclosure

The technology of the disclosure relates generally to storage media compression.

II. Background

Mobile communication devices have become increasingly common in current society. The prevalence of these mobile communication devices is driven in part by the many functions that are now enabled on such devices. Increased processing capabilities in such devices means that mobile communication devices have evolved from being purely communication tools into sophisticated mobile multimedia centers, thus enabling enhanced user experiences.

Mobile communication devices rely on storage devices to store operating systems, system parameters, executable programs, and user data. Such storage devices may include hard-disk drive (HDD), solid-state disk (SSD), universal flash storage (UFS), universal serial bus (USB) storage device, and/or embedded multimedia card (eMMC).

Concurrent to increased processing capabilities of mobile communication devices, demand for data storage capacity has also grown exponentially. As a result, it is not uncommon for mobile communication devices to be embedded with storage devices that are capable of storing hundreds of gigabytes (GBs) of data. Unfortunately, increased storage capacity comes with increased cost and complexity. As such, it is often necessary to perform data compression in the mobile communication devices to help conserve storage space in the embedded storage devices. Unfortunately, conventional compression systems, such as software-based compression systems and storage device-based compression systems, suffer obvious issues with performance, latency, and controllability.

### SUMMARY OF THE DISCLOSURE

Aspects disclosed in the detailed description include hardware-accelerated storage compression. In one aspect, prior to writing an uncompressed data block to a storage device, a hardware compression accelerator provided in a storage controller compresses the uncompressed data block into a compressed data block and allocates the compressed data block to a physical data block in the storage device. The hardware compression accelerator then generates a modified logical block address (LBA) to link the uncompressed data block to the compressed data block. In another aspect, the hardware compression accelerator locates a compressed data block based on a corresponding modified LBA and decompresses the compressed data block into an uncompressed data block. By performing hardware-accelerated storage compression in the storage controller, it is possible to reduce processing overhead associated with conventional software-based compression systems and improve compression control over conventional storage-device-driven compression systems. Further, hardware-accelerated storage compression may help improve data throughput and reduce power consumption associated with data compression.

In this regard, in one aspect, a host system is provided. The host system comprises a storage controller coupled to a storage device. The storage controller comprises a hardware compression accelerator. The host device also comprises a control system configured to provide a write request to the storage controller to write one or more uncompressed data blocks to the storage device. Each of the one or more uncompressed data blocks is associated with a respective LBA. For each uncompressed data block among the one or more uncompressed data blocks, the hardware compression accelerator is configured to compress the uncompressed data block into a compressed data block. For each uncompressed data block among the one or more uncompressed data blocks, the hardware compression accelerator is also configured to allocate the compressed data block to a physical data block in the storage device. For each uncompressed data block among the one or more uncompressed data blocks, the hardware compression accelerator is also configured to generate a modified LBA to correlate the uncompressed data block with the compressed data block.

In another aspect, a method for writing data to a storage device under a hardware-accelerated compression system is provided. The method comprises providing a write request to write one or more uncompressed data blocks to a storage device. Each of the one or more uncompressed data blocks is associated with a respective LBA. For each uncompressed data block among the one or more uncompressed data blocks, the method comprises compressing the uncompressed data block into a compressed data block. For each uncompressed data block among the one or more uncompressed data blocks, the method also comprises allocating the compressed data block to a physical data block in the storage device. For each uncompressed data block among the one or more uncompressed data blocks, the method also comprises generating a modified LBA to correlate the uncompressed data block with the compressed data block.

In another aspect, a host system is provided. The host system comprises a storage controller coupled to a storage device. The storage controller comprises a hardware compression accelerator. The host system also comprises a control system configured to provide a read request to the storage controller to read one or more uncompressed data blocks from the storage device. For each uncompressed data block among the one or more uncompressed data blocks, the control system is further configured to provide a respective modified LBA that correlates the uncompressed data block with a respective compressed data block in the storage device. For each uncompressed data block among the one or more uncompressed data blocks, the storage controller is configured to retrieve the respective compressed data block from the storage device based on the respective modified LBA. For each uncompressed data block among the one or more uncompressed data blocks, the hardware compression accelerator is configured to decompress the respective compressed data block into the uncompressed data block. For each uncompressed data block among the one or more uncompressed data blocks, the storage controller is further configured to provide the uncompressed data block to the control system.

In another aspect, a method for reading data from a storage device under a hardware-accelerated compression system is provided. The method comprises providing a read request to read one or more uncompressed data blocks from a storage device. For each uncompressed data block among the one or more uncompressed data blocks, the method comprises providing a respective modified LBA that correlates the uncompressed data block with a respective compressed data block in the storage device. For each uncompressed data block among the one or more uncompressed data blocks, the method also comprises retrieving the respective compressed data block from the storage device based on the respective modified LBA. For each uncompressed data block among the one or more uncompressed data blocks, the method also comprises decompressing the respective compressed data block into the uncompressed data block.

### BRIEF DESCRIPTION OF THE FIGURES

FIG. 1A is a schematic diagram of an exemplary host system configured to perform storage compression based on a conventional software-based compression system;

FIG. 1B is a schematic diagram of an exemplary host system configured to perform storage compression based on a conventional storage-device-driven compression system;

FIG. 2 is a schematic diagram of an exemplary host system configured to write one or more uncompressed data blocks to a storage device based on a hardware-accelerated storage compression system;

FIG. 3 is a schematic diagram providing an exemplary illustration of an indexed-node (inode) that contains one or more modified logical block addresses (LBAs) configured to link the one or more uncompressed data blocks of FIG. 2 with one or more compressed data blocks, respectively;

FIG. 4 is a schematic diagram providing an exemplary illustration of correlations between uncompressed data blocks, compressed data blocks, modified LBAs, and LBAs;

FIG. 5 is a schematic diagram of an exemplary host system configured to read one or more uncompressed data blocks that are generated based on the hardware-accelerated compression system of FIG. 2 from the storage device;

FIG. 6 is a flowchart of an exemplary write process for writing the one or more uncompressed data blocks of FIG. 2 to the storage device under the hardware-accelerated compression system;

FIG. 7 is a flowchart of an exemplary read process for reading the one or more uncompressed data blocks of FIG. 5 under the hardware-accelerated compression system; and

FIG. 8 is a block diagram of an exemplary processor-based system that can employ the host systems of FIGS. 2 and 5 that supports the hardware-accelerated storage compression system.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include hardware-accelerated storage compression. In one aspect, prior to writing an uncompressed data block to a storage device, a hardware compression accelerator provided in a storage controller compresses the uncompressed data blocks individually into a compressed data block and allocates the compressed data block to a physical data block in the storage device. The hardware compression accelerator then generates a modified logical block address (LBA) to link the uncompressed data block to the compressed data block. In another aspect, the hardware compression accelerator locates a compressed data block based on a corresponding modified LBA and decompresses the compressed data block into an uncompressed data block. By performing hardware-accelerated storage compression in the storage controller, it is possible to reduce processing overhead associated with conventional software-based compression systems and improve compression control over conventional storage-device-driven compression systems. Further, hardware-accelerated storage compression may help improve data throughput and reduce power consumption associated with data compression.

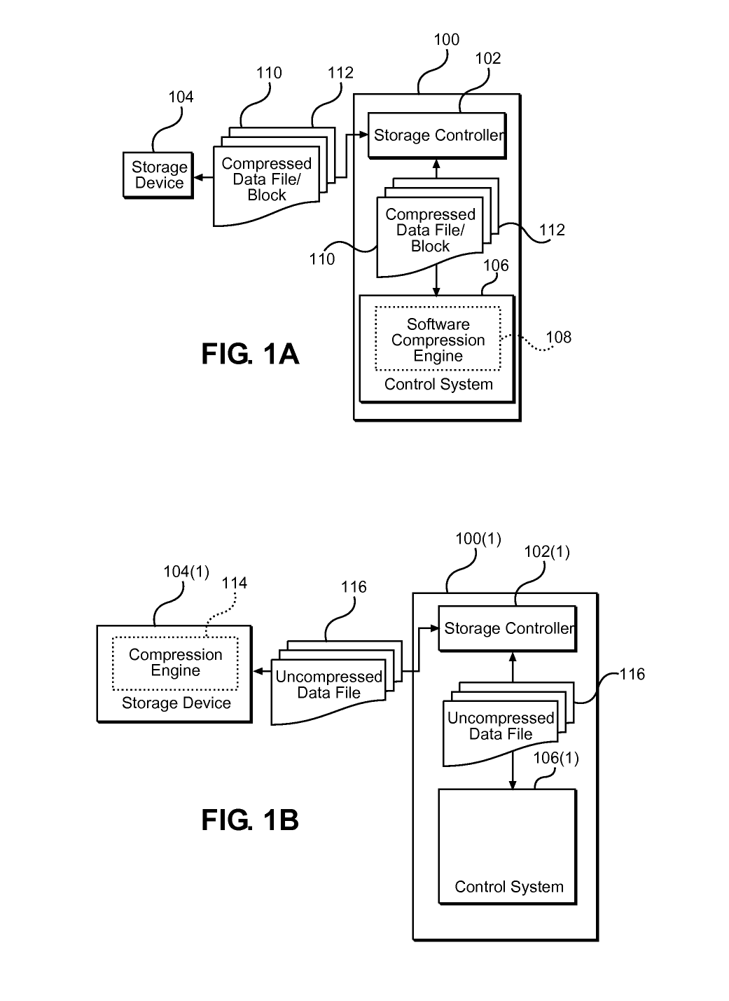

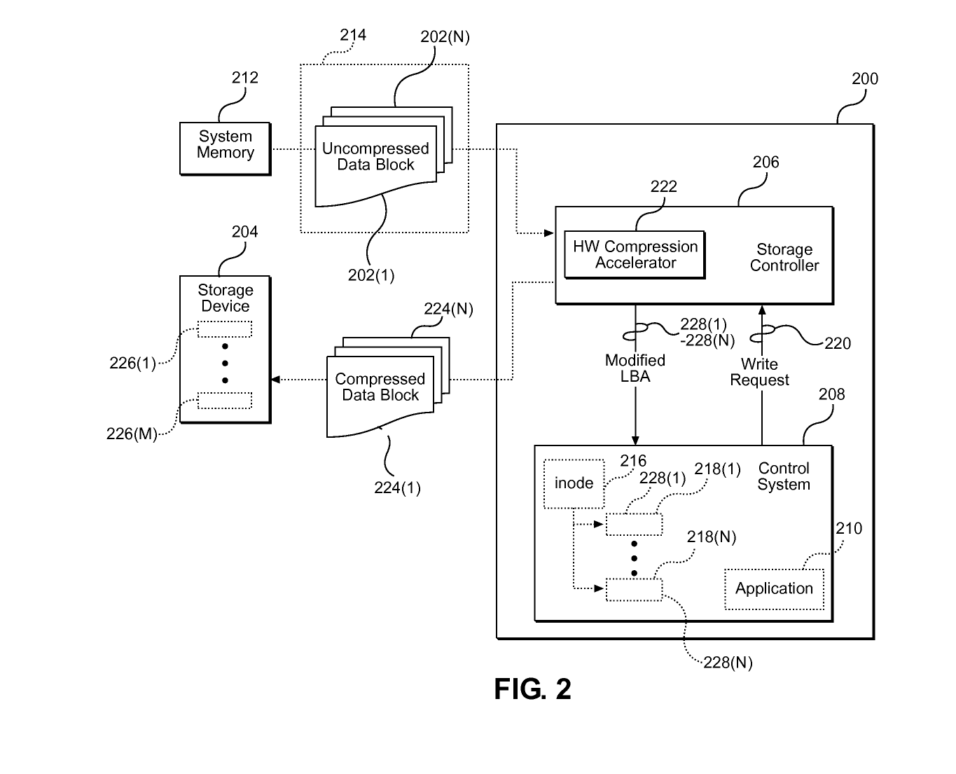

Before discussing exemplary aspects of hardware-accelerated storage compression that include specific aspects of the present disclosure, a brief overview of a conventional software-based compression system and a conventional storage-device-driven compression system are provided with reference to FIGS. 1A and 1B, respectively. The discussion of specific exemplary aspects of hardware accelerated storage compression starts with reference to FIG. 2.

In this regard, FIG. 1A is a schematic diagram of an exemplary host system 100 configured to perform storage compression based on a conventional software-based compression system.

The host system 100 includes a storage controller 102 configured to enable read/write access to a storage device 104 coupled to the host system 100. The host system 100 also includes a control system 106 that is configured to provide data access to applications running in the host system 100.

When an application requests to write a data file (not shown) to the storage device 104, the control system 106 first generates an indexed-node (inode) (not shown) to store related metadata (e.g., file name, file owner, file access permission, etc.). Prior to writing the data file to the storage device 104, a software compression engine 108 compresses the data file to save storage space in the storage device 104. In a non-limiting example, the software compression engine 108 (e.g., WinZip) may compress the data file in to a single compressed data file 110. In another non-limiting example, the software compression engine 108 may compress the data file into a plurality of compressed data blocks 112. Each of the plurality of compressed data blocks 112 may be one hundred and twenty-eight kilobytes (128 KB) in size. Subsequently, the storage controller 102 writes the single compressed data file 110 or the plurality of compressed data blocks 112 to the storage device 104. In a non-limiting example, the storage device 104 may include physical data blocks that are four kilobytes (4 KB) in size. As such, the single compressed data file 110 or the plurality of compressed data blocks 112 may occupy multiple physical data blocks.

With continuing reference to FIG. 1A, when the application needs to access the data file stored in the storage device 104, the storage controller 102 reads the single compressed data file 110 or the plurality of compressed data blocks 112 from the storage device 104. The control system 106 then decompresses the single compressed data file 110 or the plurality of compressed data blocks 112 for the application.

The conventional software-based compression system carries significant processing delays due to compression/decompression processes performed by the software compression engine 108. Furthermore, because the conventional software-based compression system compresses the data file into either the single compressed data file 110 or the plurality of compressed data blocks 112 that are 128 KB in size, the control system 106 must read and decompress the single compressed data file 110 or a 128 KB compressed data block among the plurality of compressed data blocks 112 even if the application only requests to read a small portion (e.g. 4 KB) of the data file. As a result, the conventional software-based compression system also carries significant processing overhead.

As an alternative to performing data compression/decompression in the host system 100, it is also possible to perform the data compression/decompression in the storage device 104. In this regard, FIG. 1B is a schematic diagram of an exemplary host system 100(1) configured to perform storage compression based on a conventional storage-device-driven compression system.

With reference to FIG. 1B, The host system 100(1) includes a storage controller 102(1) configured to enable read/write access to a storage device 104(1) coupled to the host system 100(1). The host system 100(1) also includes a control system 106(1) that is configured to provide data access to applications running in the host system 100(1). The storage device 104(1) includes a compression engine 114 configured to support the conventional storage-device-driven compression system.

When an application requests to write an uncompressed data file 116 to the storage device 104(1), the storage controller 102(1) sends the uncompressed data file 116 to the storage device 104(1). Prior to writing the uncompressed data file 116 into physical data blocks (not shown) in the storage device 104(1), the compression engine 114 compresses the uncompressed data file 116 into a plurality of compressed data blocks (not shown) based on compression algorithms that are typically unknown to the host system 100(1). In other words, the host system 100(1) has no knowledge or control over how the compression is performed by the compression engine 114.

When the application requests to read the uncompressed data file 116 from the storage device 104(1), the compression engine 114 decompresses the plurality of compressed data blocks corresponding to the uncompressed data file 116 and provides the uncompressed data file 116 back to the host system 100(1). As such, the control system 106(1) also has no control over how the compression engine 114 compresses the uncompressed data file 116.

As discussed above in FIGS. 1A and 1B, the conventional software-based compression system and the conventional storage-device-driven compression system both have obvious drawbacks. The conventional software-based compression system incurs processing delays and processing overhead while the conventional storage-device-driven compression system gives no control to the host system. Hence, it may be desirable to have a compression system that can reduce the processing delays and processing overhead associated with the conventional software-based compression system while improving compression control over the conventional storage-device-driven compression system.

In this regard, FIG. 2 is a schematic diagram of an exemplary host system 200 configured to write one or more uncompressed data blocks 202(1)-202(N) to a storage device 204 based on a hardware-accelerated storage compression system.

The host system 200 includes a storage controller 206 configured to enable read/write access to the storage device 204. In a non-limiting example, the storage device 204 may be a hard-disk drive (HDD), a solid-state disk (SSD), an embedded multimedia card (eMMC), a universal flash storage (UFS), and/or a universal serial bus (USB) storage device. In another non-limiting example, the storage device 204 may be embedded in the host system 200 or coupled externally to the host system 200. The host system 200 also includes a control system 208, which may be an operating system (OS) and/or file system (FS) for example, that is configured to provide data access to an application 210 running in the host system 200. In a non-limiting example, the OS may be Android, iOS, Windows, Linux, and/or Unix.

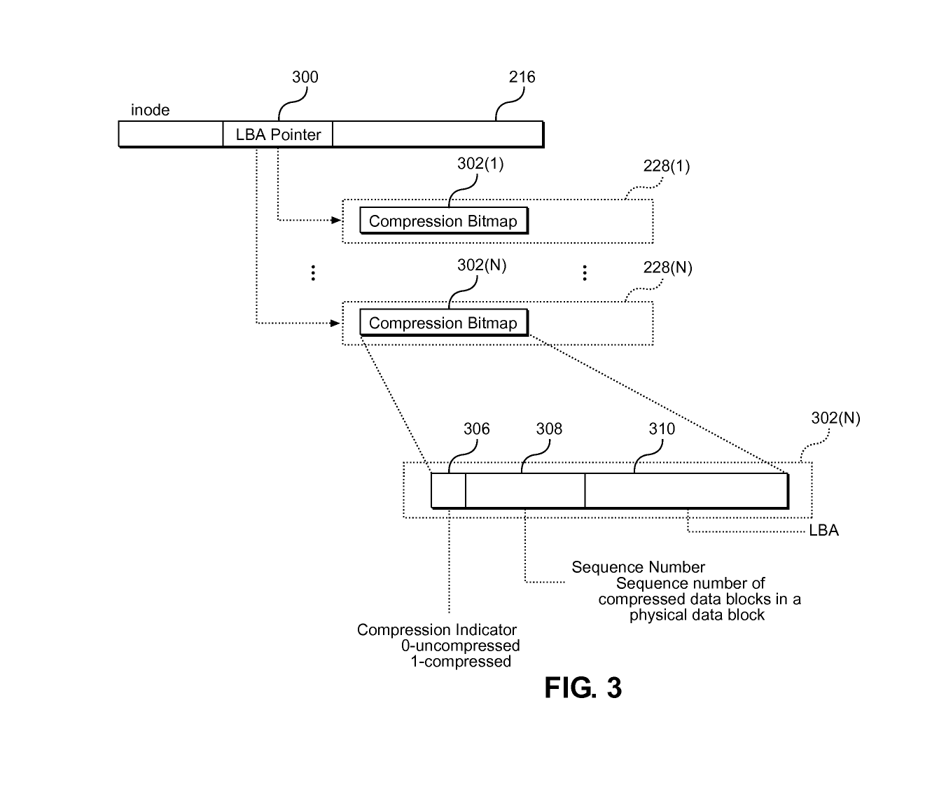

When the application 210 is running in the host system 200, the application 210 may generate and temporarily store the one or more uncompressed data blocks 202(1)-202(N) in a system memory 212, for example. In a non-limiting example, the system memory 212 may be a dynamic random access memory (DRAM). When the application 210 needs to store permanently the one or more uncompressed data blocks 202(1)-202(N) in form of a data file 214, the control system 208 generates an inode 216 to store metadata related to the data file 214 and the one or more uncompressed data blocks 202(1)-202(N). In a non-limiting example, the inode 216 is provided as a data structure and contains such metadata (e.g., file name, file owner, file access permission, etc.) that defines the data file 214. The inode 216 also contains an LBA pointer (not shown) that points to one or more LBAs 218(1)-218(N) associated with the one or more uncompressed data blocks 202(1)-202(N), respectively. The one or more LBAs 218(1)-218(N) may be used by the control system 208 to locate the one or more uncompressed data blocks 202(1)-202(N) in the data file 214. In a non-limiting example, each of the one or more LBAs 218(1)-218(N) has a respective length of thirty-two (32) bits that can address two to the power of thirty-two (2³²) data blocks. The structure and content of the inode 216 is further illustrated and discussed with reference to FIG. 3.

Subsequent to defining the data file 214 in the inode 216, the control system 208 sends a write request 220 to the storage controller 206 to write the one or more uncompressed data blocks 202(1)-202(N) to the storage device 204. The storage controller 206 includes a hardware compression accelerator 222 configured to support the hardware-accelerated storage compression system. The hardware compression accelerator 222 compresses the one or more uncompressed data blocks 202(1)-202(N) to generate one or more compressed data blocks 224(1)-224(N), respectively. According to a non-limiting example, the hardware compression accelerator 222 is configured to compress each of the one or more uncompressed data blocks 202(1)-202(N) individually. As a result, respective sizes of the one or more compressed data blocks 224(1)-224(N) will be no larger than respective sizes of the one or more uncompressed data blocks 202(1)-202(N).

Although the hardware compression accelerator 222 is configured to compress each of the one or more uncompressed data blocks 202(1)-202(N) using the same compression algorithm, the one or more compressed data blocks 224(1)-224(N) may not be the same size. For example, if each of the one or more uncompressed data blocks 202(1)-202(N) is 4 KB in size, each of the one or more compressed data blocks 224(1)-224(N) can be any size that is less than or equal to 4 KB. Accordingly, if a compressed data block among the one or more compressed data blocks 224(1)-224(N) is still 4 KB in size after being compressed by the hardware compression accelerator 222, the compressed data block is in fact uncompressed. As such, it is possible for the hardware compression accelerator 222 to determine whether a compressed data block among the one or more compressed data blocks 224(1)-224(N) is compressed or uncompressed by comparing the respective size of the compressed data block against the respective size of the uncompressed data block among the one or more uncompressed data blocks 202(1)-202(N).

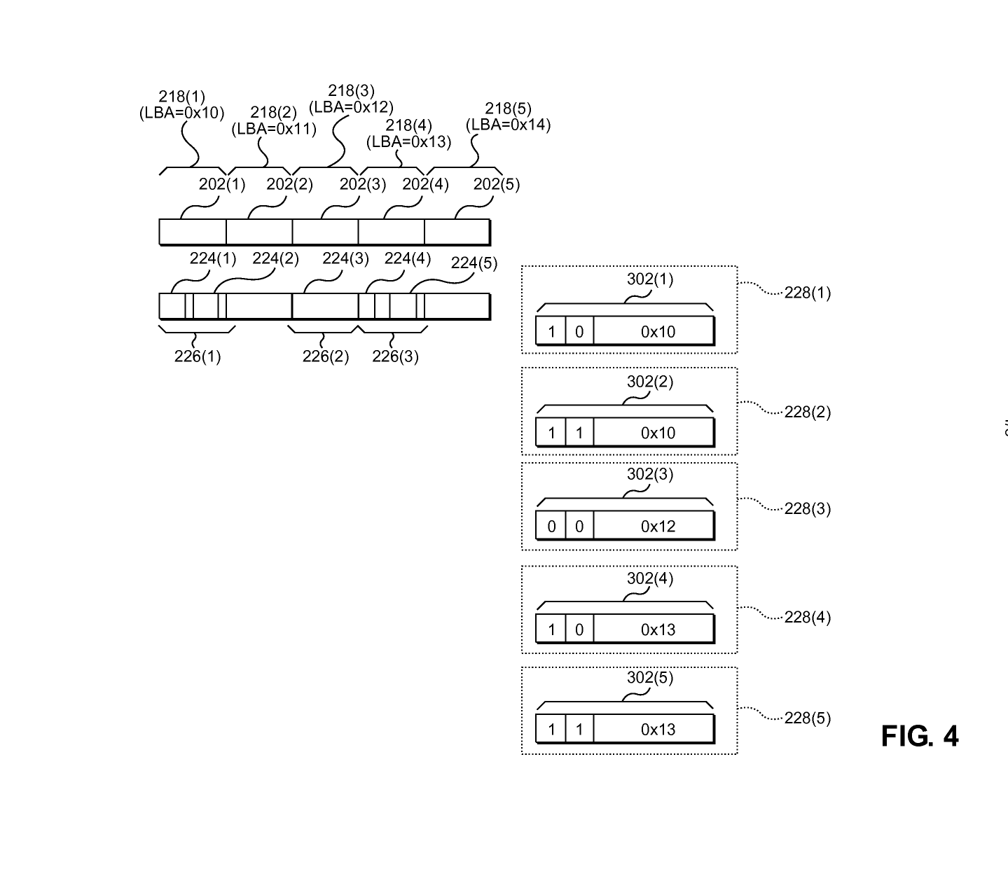

With continuing reference to FIG. 2, the hardware compression accelerator 222 is further configured to allocate each of the one or more compressed data blocks 224(1)-224(N) to one or more physical data blocks 226(1)-226(M) in the storage device 204. In a non-limiting example, each of the one or more physical data blocks 226(1)-226(M) is 4 KB in size. Since the one or more compressed data blocks 224(1)-224(N) can be any size that is less than or equal to 4 KB, it may be possible for the hardware compression accelerator 222 to co-locate a compressed data block among the one or more compressed data blocks 224(1)-224(N) with at least one other compressed data block among the one or more compressed data blocks 224(1)-224(N) in a physical data block among the one or more physical data blocks 226(1)-226(M). As a result, the hardware compression accelerator 222 may store the one or more compressed data blocks 224(1)-224(N) in fewer of the physical data blocks 226(1)-226(M), thus conserving storage space in the storage device 204. A more detailed discussion with respect to physical data block allocation is provided later with reference to FIG. 4.

Subsequently, the storage controller 206 is configured to write the one or more compressed data blocks 224(1)-224(N) to the one or more physical data blocks 226(1)-226(M). To help the control system 208 locate the one or more compressed data blocks 224(1)-224(N) based on the one or more LBAs 218(1)-218(N), the hardware compression accelerator 222 generates and provides one or more modified LBAs 228(1)-228(N) to the control system 208. The one or more modified LBAs 228(1)-228(N) are configured to correlate the one or more LBAs 218(1)-218(N) with the one or more compressed data blocks 224(1)-224(N), respectively. The control system 208 receives the one or more modified LBAs 228(1)-228(N) and stores the one or more modified LBAs 228(1)-228(N) in the inode 216 in correlation with the one or more LBAs 218(1)-218(N), respectively. As illustrated next with reference to FIGS. 3 and 4, the one or more modified LBAs 228(1)-228(N) effectively correlate the one or more uncompressed data blocks 202(1)-202(N) with the one or more compressed data blocks 224(1)-224(N).

In this regard, FIG. 3 is a schematic diagram providing an exemplary illustration of the inode 216 of FIG. 2 that contains the one or more modified LBAs 228(1)-228(N) configured to correlate the one or more uncompressed data blocks 202(1)-202(N) with the one or more compressed data blocks 224(1)-224(N), respectively. Elements of FIG. 2 are referenced in connection with FIG. 3 and will not be re-described herein.

With reference to FIG. 3, the inode 216 includes an LBA pointer 300 that points to the one or more modified LBAs 228(1)-228(N). The one or more modified LBAs 228(1)-228(N) comprise one or more compression bitmaps 302(1)-302(N), respectively.

For the convenience of illustration, compression bitmap 302(N) in modified LBA 228(N) is discussed herein as a non-limiting example. It should be understood that the illustrations provided herein with references to the compression bitmap 302(N), the modified LBA 228(N), LBA 218(N) of FIG. 2, uncompressed data block 202(N) of FIG. 2, and compressed data block 224(N) of FIG. 2 are applicable to all of the one or more compression bitmaps 302(1)-302(N).

With continuing reference to FIG. 3, the compression bitmap 302(N) includes a compression indicator 306, a sequence number 308, and an LBA number 310. In a non-limiting example, the compression indicator 306 is one bit (1-bit) in length. The hardware compression accelerator 222 sets the compression indicator 306 to one (1) if the uncompressed data block 202(N) is compressed and to zero (0) if the uncompressed data block 202(N) is uncompressed. To determine whether the uncompressed data block 202(N) is compressed or uncompressed, the hardware compression accelerator 222 of FIG. 2 is configured to compare the respective size of the compressed data block 224(N) and the respective size of the uncompressed data block 202(N). If the respective size of the compressed data block 224(N) is less than the respective size of the uncompressed data block 202(N), the uncompressed data block 202(N) is deemed to be compressed and the hardware compression accelerator 222 sets the compression indicator 306 to 1. In contrast, if the respective size of the compressed data block 224(N) is equal to the respective size of the uncompressed data block 202(N), the uncompressed data block 202(N) is deemed to be uncompressed and the hardware compression accelerator 222 sets the compression indicator 306 to 0.

As previously discussed with reference to FIG. 2, it may be possible to co-locate a compressed data block among the one or more compressed data blocks 224(1)-224(N) with at least one other compressed data block among the one or more compressed data blocks 224(1)-224(N) in a physical data block among the one or more physical data blocks 226(1)-226(M). In a non-limiting example, a predetermined allocation limit may be pre-programmed in the hardware compression accelerator 222 to define a maximum number of compressed data blocks that can be co-located by the hardware compression accelerator 222 in each of the one or more physical data blocks 226(1)-226(M). As such, the sequence number 308 is configured to indicate relative sequence of the compressed data block 224(N) in the physical data block if the compressed data block 224(N) is co-located with the at least one other compressed data block among the one or more compressed data blocks 224(1)-224(N). The number of bits in the sequence number 308 (sometimes referred to as N_{BIT}) can be determined based on the predetermined allocation limit in equation Eq. 1 below.

N_{BIT}=┌log₂ (Predetermined Allocation Limit)┐ (Eq. 1)

The LBA number 310 is configured to indicate the LBA 218(N) that corresponds to the modified LBA 228(N) in the inode 216. In a non-limiting example, the LBA number 310 may be expressed in hexadecimal format.

To help further understand how the one or more compression bitmaps 302(1)-302(N) can correlate the one or more uncompressed data blocks 202(1)-202(N) of FIG. 2 with the one or more compressed data blocks 224(1)-224(N), FIG. 4 is provided next. For the purpose of clarity and convenience, uncompressed data blocks 202(1)-202(5), compressed data blocks 224(1)-224(5), modified LBAs 228(1)-228(5), and LBAs 218(1)-218(5) are illustrated and discussed herein as non-limiting examples.

In this regard, FIG. 4 is a schematic diagram providing an exemplary illustration of correlations between the uncompressed data blocks 202(1)-202(5), the compressed data blocks 224(1)-224(5), the modified LBAs 228(1)-228(5), and the LBAs 218(1)-218(5). Common elements between FIGS. 2, 3, and 4 are shown therein with common element numbers and will not be re-described herein.

As illustrated in FIG. 4, in a non-limiting example, the LBAs 218(1)-218(5) have respective values of hexadecimal ten (0x10), hexadecimal eleven (0x11), hexadecimal twelve (0x12), hexadecimal thirteen (0x13) and hexadecimal fourteen (0x14).

With reference to FIG. 4, the compressed data block 224(1) is co-located with the compressed data block 224(2) in a physical data block 226(1). The hardware compression accelerator 222 of FIG. 2 determines whether the compressed data block 224(1) can be co-located with the compressed data block 224(2) based on two tests. The first test is to make sure that total size of the compressed data block 224(1) and the compressed data block 224(2) is less than or equal to the size of the physical data block 226(1), which is 4 KB according to the non-limiting example provided with reference to FIG. 2. In this regard, if the first test is passed, the compressed data blocks 224(1)-224(2) are smaller in size than the uncompressed data blocks 202(1)-202(2), respectively.

With continuing reference to FIG. 4, the second test is to make sure that total number of the compressed data block 224(1) and the compressed data block 224(2) is less than or equal to the predetermined allocation limit that defines the total number of compressed data blocks that can be allocated per physical data block. If the predetermined allocation limit is set to two, for example, the compressed data block 224(1) and the compressed data block 224(2) will pass the second test.

In this regard, in compression bitmap 302(1), the compression indicator 306 is set to 1 by the hardware compression accelerator 222 to indicate that the uncompressed data block 202(1) is compressed. The sequence number 308 is set to 0 to indicate that the compressed data block 224(1) is the first compressed data block in the physical data block 226(1). The LBA number 310 is set to 0x10, which indicates the LBA value of the uncompressed data block 202(1), by the hardware compression accelerator 222. Accordingly, the modified LBA 228(1), the uncompressed data block 202(1), and the compressed data block 224(1) become correlated to each other.

In compression bitmap 302(2), the compression indicator 306 is set to 1 to indicate that the uncompressed data block 202(2) is compressed. The sequence number 308 is set to 1 by the hardware compression accelerator 222 to indicate that the compressed data block 224(2) is the second compressed data block in the physical data block 226(1). The LBA number 310 is set to 0x11, which indicates the LBA value of the uncompressed data block 202(2), by the hardware compression accelerator 222.

With continuing reference to FIG. 4, the compressed data block 224(3) is allocated to the physical data block 226(2) alone. As illustrated, the size of the compressed data block 224(3) is the same as the uncompressed data block 202(3). According to previous discussion with reference to FIG. 2, the uncompressed data block 202(3) remains uncompressed after being compressed by the hardware compression accelerator 222. In this regard, in compression bitmap 302(3), the compression indicator 306 is set to 0 to indicate that the uncompressed data block 202(3) remains uncompressed. The sequence number 308 is set to 0 by the hardware compression accelerator 222 to indicate that the compressed data block 224(3) is the first compressed data block in the physical data block 226(2). The LBA number 310 is set to 0x12, which is the LBA value of the uncompressed data block 202(3), by the hardware compression accelerator 222.

With continuing reference to FIG. 4, the compressed data blocks 224(4)-224(5) are co-located to the physical data block 226(3). As such, in compression bitmap 302(4), the compression indicator 306 is set to 1 by the hardware compression accelerator 222 to indicate that the uncompressed data block 202(4) is compressed. The sequence number 308 is set to 0 to indicate that the compressed data block 224(4) is the first compressed data block in the physical data block 226(3). The LBA number 310 is set to 0x13, which is the LBA value of the uncompressed data block 202(4), by the hardware compression accelerator 222.

In compression bitmap 302(5), the compression indicator 306 is set to 1 to indicate that the uncompressed data block 202(5) is compressed. The sequence number 308 is set to 1 by the hardware compression accelerator 222 to indicate that the compressed data block 224(5) is the second compressed data block in the physical data block 226(3). The LBA number 310 is also set to 0x14, which is the LBA value of the uncompressed data block 202(5), by the hardware compression accelerator 222.

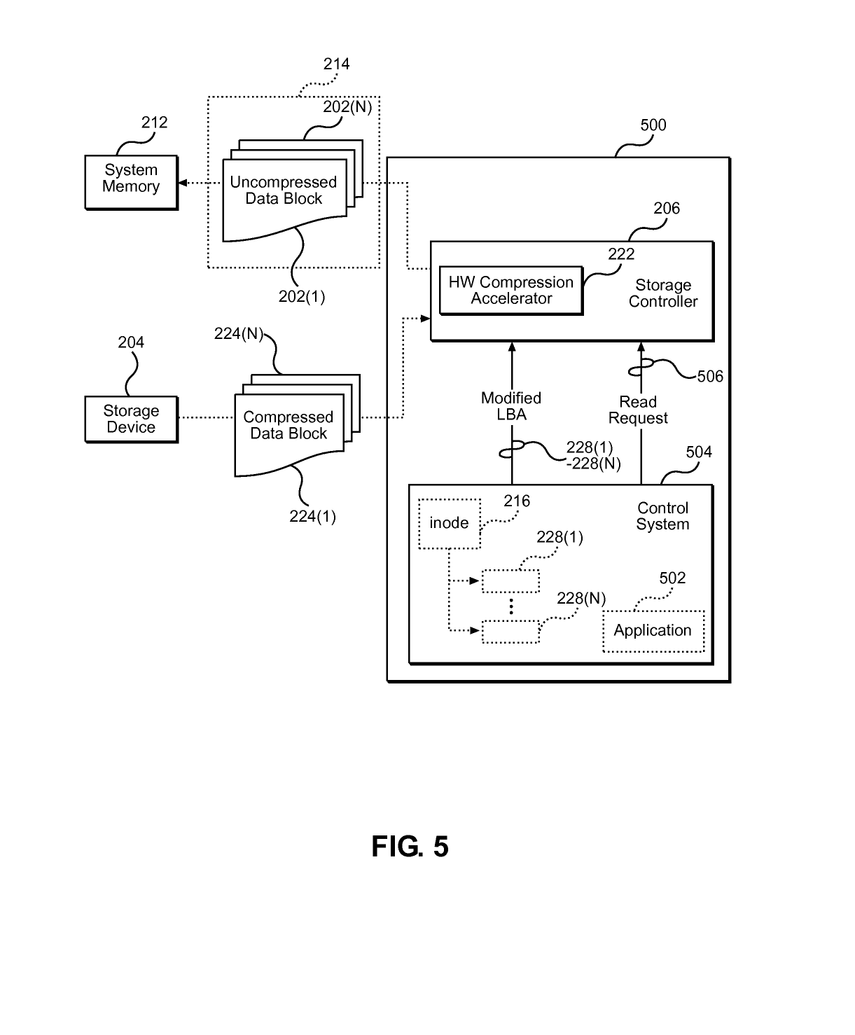

As previously discussed with reference to FIG. 2, the hardware compression accelerator 222 generates the one or more modified LBAs 228(1)-228(N) to help the control system 208 locate the one or more compressed data blocks 224(1)-224(N). As such, it is possible for the control system 208 to read the one or more compressed data blocks 224(1)-224(N) from the storage device 204 based on the one or more modified LBAs 228(1)-228(N) stored in the inode 216. In this regard, FIG. 5 is a schematic diagram of an exemplary host system 500 configured to read the one or more uncompressed data blocks 202(1)-202(N) of FIG. 2 from the storage device 204 based on the one or more modified LBAs 228(1)-228(N), respectively. Common elements between FIGS. 2 and 5 are shown therein with common element numbers and will not be re-described herein.

With reference to FIG. 5, when an application 502 needs to read the data file 214 that includes the one or more uncompressed data blocks 202(1)-202(N) from the storage device 204, a control system 504 provides a read request 506, together with the one or more modified LBAs 228(1)-228(N), to the storage controller 206. According to previous discussion with reference to FIGS. 2-4, the one or more modified LBAs 228(1)-228(N) correlate the one or more uncompressed data blocks 202(1)-202(N) with the one or more compressed data blocks 224(1)-224(N). As such, the storage controller 206 retrieves the one or more compressed data blocks 224(1)-224(N) from the storage device 204. The hardware compression accelerator 222 decompresses the one or more compressed data blocks 224(1)-224(N) to the one or more uncompressed data blocks 202(1)-202(N), respectively. In a non-limiting example, the one or more uncompressed data blocks 202(1)-202(N) are stored in the system memory 212 for access by the application 502.

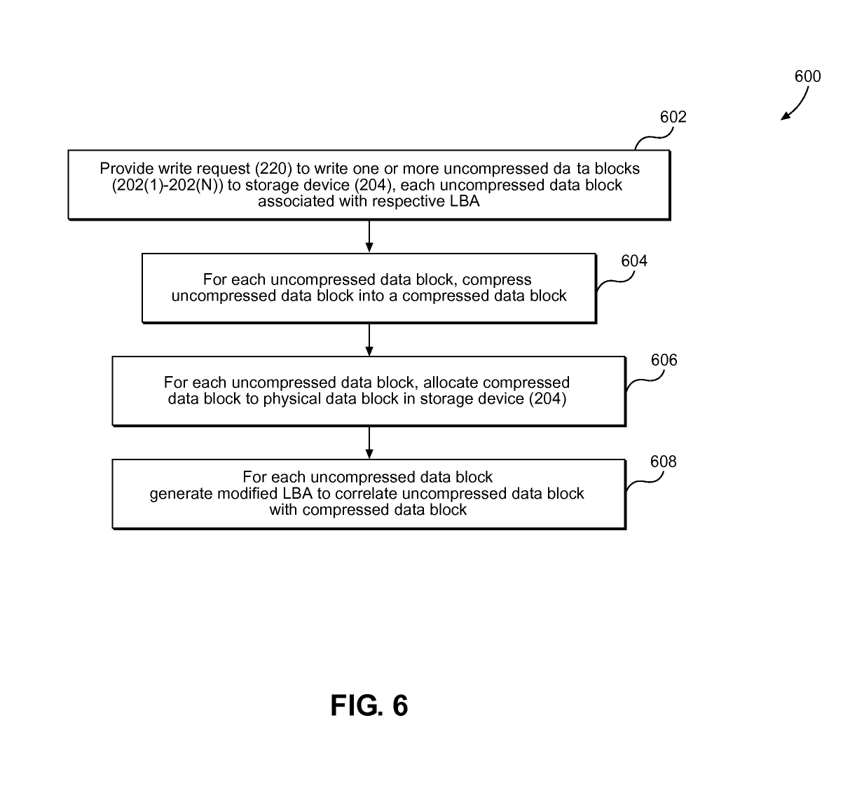

FIG. 6 is a flowchart of an exemplary write process 600 for writing the one or more uncompressed data blocks 202(1)-202(N) of FIG. 2 to the storage device 204 under the hardware-accelerated compression system. Elements of FIG. 2 are referenced in connection with FIG. 6 and will not be re-described herein.

According to the write process 600, the control system 208 provides the write request 220 to write the one or more uncompressed data blocks 202(1)-202(N) to the storage device 204, in which each of the one or more uncompressed data blocks 202(1)-202(N) is associated with a respective LBA among the one or more LBAs 218(1)-218(N) (block 602). For each uncompressed data block among the one or more uncompressed data blocks 202(1)-202(N), the hardware compression accelerator 222 compresses the uncompressed data block into a compressed data block (block 604). Subsequently, for each uncompressed data block among the one or more uncompressed data blocks 202(1)-202(N), the hardware compression accelerator 222 allocates the compressed data block to a physical data block in the storage device 204 (block 606). Then, for each uncompressed data block among the one or more uncompressed data blocks 202(1)-202(N), the hardware compression accelerator 222 generates a modified LBA to correlate the uncompressed data block with the compressed data block (block 608).

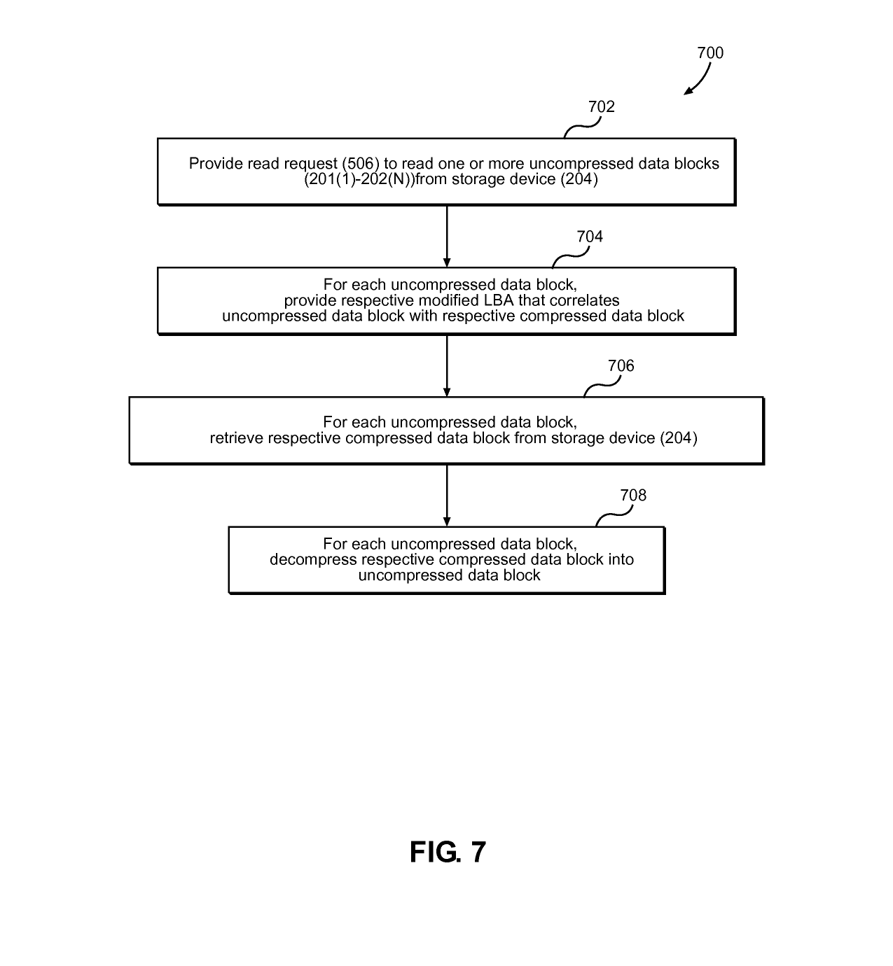

FIG. 7 is a flowchart of an exemplary read process 700 for reading the one or more uncompressed data blocks 202(1)-202(N) of FIG. 5 from the storage device 204 under the hardware-accelerated compression system. Elements of FIG. 5 are referenced in connection with FIG. 7 and will not be re-described herein.

According to the read process 700, the control system 504 provides the read request 506 to read the one or more uncompressed data blocks 202(1)-202(N) from the storage device 204 (block 702). For each uncompressed data block among the one or more uncompressed data blocks 202(1)-202(N), the control system 504 provides a respective modified LBA that correlates the uncompressed data block with a respective compressed data block (block 704). Subsequently, for each uncompressed data block among the one or more uncompressed data blocks 202(1)-202(N), the storage controller 206 retrieves the respective compressed data block from the storage device 204 (block 706). Then, for each uncompressed data block among the one or more uncompressed data blocks 202(1)-202(N), the hardware compression accelerator 222 decompresses the respective compressed data block into the uncompressed data block (block 708).

The host system 200 of FIG. 2 and the host system 500 of FIG. 5 may be provided in or integrated into any processor-based device. Examples, without limitation, include a set top box, an entertainment unit, a navigation device, a communications device, a fixed location data unit, a mobile location data unit, a mobile phone, a cellular phone, a smartphone, a tablet, a phablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

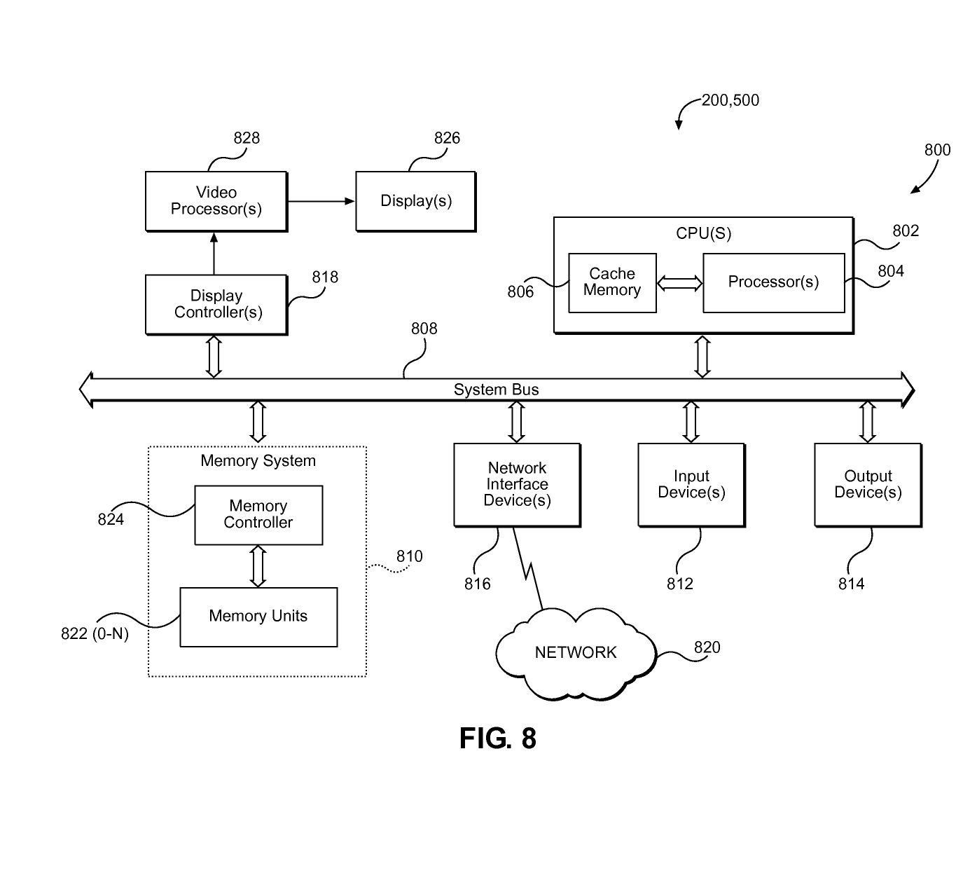

In this regard, FIG. 8 illustrates an example of a processor-based system 800 that can employ the host system 200 of FIG. 2 and the host system 500 of FIG. 5. In this example, the processor-based system 800 includes one or more central processing units (CPUs) 802, each including one or more processors 804. The CPU(s) 802 may have cache memory 806 coupled to the processor(s) 804 for rapid access to temporarily stored data. The CPU(s) 802 is coupled to a system bus 808. As is well known, the CPU(s) 802 communicates with other devices by exchanging address, control, and data information over the system bus 808. Although not illustrated in FIG. 8, multiple system buses 808 could be provided, wherein each system bus 808 constitutes a different fabric.

Other master and slave devices can be connected to the system bus 808. As illustrated in FIG. 8, these devices can include a memory system 810, one or more input devices 812, one or more output devices 814, one or more network interface devices 816, and one or more display controllers 818, as examples. The input device(s) 812 can include any type of input device, including, but not limited to, input keys, switches, voice processors, etc. The output device(s) 814 can include any type of output device, including, but not limited to, audio, video, other visual indicators, etc. The network interface device(s) 816 can be any device configured to allow exchange of data to and from a network 820. The network 820 can be any type of network, including, but not limited to, a wired or wireless network, a private or public network, a local area network (LAN), a wireless local area network (WLAN), a wide area network (WAN), a BLUETOOTH™ network, or the Internet. The network interface device(s) 816 can be configured to support any type of communications protocol desired. The memory system 810 can include one or more memory units 822(0-N) and a memory controller 824.

The CPU(s) 802 may also be configured to access the display controller(s) 818 over the system bus 808 to control information sent to one or more displays 826. The display controller(s) 818 sends information to the display(s) 826 to be displayed via one or more video processors 828, which process the information to be displayed into a format suitable for the display(s) 826. The display(s) 826 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A host system, comprising:
a storage controller coupled to a storage device, wherein the storage controller comprises a hardware compression accelerator;
a control system configured to provide a write request to the storage controller to write one or more uncompressed data blocks to the storage device, wherein each of the one or more uncompressed data blocks is associated with a respective logical block address (LBA); and
for each uncompressed data block among the one or more uncompressed data blocks, the hardware compression accelerator is configured to:
compress the uncompressed data block into a compressed data block;
allocate the compressed data block to a physical data block in the storage device; and
generate a modified LBA to correlate the uncompressed data block with the compressed data block.

2. The host system of claim 1, wherein for each uncompressed data block among the one or more uncompressed data blocks, the control system is further configured to:
receive the modified LBA from the hardware compression accelerator; and
update the respective LBA in an indexed-node (inode) with the modified LBA.

3. The host system of claim 1, wherein for each uncompressed data block among the one or more uncompressed data blocks, the storage controller is configured to write the compressed data block to the physical data block allocated by the hardware compression accelerator.

4. The host system of claim 1, wherein the hardware compression accelerator is further configured to co-locate the compressed data block with at least one other compressed data block in the physical data block if:
total size of the compressed data block and the at least one other compressed data block is less than or equal to size of the physical data block; and
total number of the compressed data block and the at least one other compressed data block is less than or equal to a predetermined allocation limit of the physical data block.

5. The host system of claim 1, wherein the modified LBA comprises a compression bitmap, comprising:
a compression indicator configured to indicate whether the compressed data block is compressed;
a sequence number configured to indicate relative sequence of the compressed data block in the physical data block in which the compressed data block is stored; and
an LBA number configured to indicate the respective LBA of the uncompressed data block corresponding to the compressed data block.

6. The host system of claim 5, wherein the physical data block and the uncompressed data block each have a size of four kilobytes (4 KB).

7. The host system of claim 1, wherein the storage device coupled to the storage controller is selected from the group consisting of: a hard-disk drive (HDD); a solid-state disk (SSD); an embedded multimedia card (eMMC); a universal flash storage (UFS); and a universal serial bus (USB) device.

8. The host system of claim 1 integrated into an integrated circuit (IC).

9. The host system of claim 1 integrated into a device selected from the group consisting of: a set top box; an entertainment unit; a navigation device; a communications device; a fixed location data unit; a mobile location data unit; a mobile phone; a cellular phone; a smart phone; a tablet; a phablet; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

10. A method for writing data to a storage device under a hardware-accelerated compression system, comprising:
providing a write request to write one or more uncompressed data blocks to a storage device, each of the one or more uncompressed data blocks associated with a respective logical block address (LBA); and
for each uncompressed data block among the one or more uncompressed data blocks:
compressing the uncompressed data block into a compressed data block;
allocating the compressed data block to a physical data block in the storage device; and
generating a modified LBA to correlate the uncompressed data block with the compressed data block.

11. The method of claim 10, further comprising updating the respective LBA in an indexed-node (inode) with the modified LBA for each uncompressed data block among the one or more uncompressed data blocks.

12. The method of claim 10, further comprising writing the compressed data block to the physical data block for each uncompressed data block among the one or more uncompressed data blocks.

13. The method of claim 10, further comprising co-locating the compressed data block with at least one other compressed data block in the physical data block if:
total size of the compressed data block and the at least one other compressed data block is less than or equal to size of the physical data block; and
total number of the compressed data block and the at least one other compressed data block is less than or equal to a predetermined allocation limit for the physical data block.

14. A host system, comprising:
a storage controller coupled to a storage device, wherein the storage controller comprises a hardware compression accelerator;
a control system configured to provide a read request to the storage controller to read one or more uncompressed data blocks from the storage device; and
for each uncompressed data block among the one or more uncompressed data blocks:
the control system is further configured to provide a respective modified logical block address (LBA) that correlates the uncompressed data block with a respective compressed data block in the storage device;
the storage controller is configured to retrieve the respective compressed data block from the storage device based on the respective modified LBA;
the hardware compression accelerator is configured to decompress the respective compressed data block into the uncompressed data block; and
the storage controller is further configured to provide the uncompressed data block to the control system.

15. The host system of claim 14, wherein the respective modified LBA comprises a compression bitmap, comprising:
a compression indicator configured to indicate whether the respective compressed data block is compressed;
a sequence number configured to indicate relative sequence of the respective compressed data block in a physical data block in which the respective compressed data block is stored; and
an LBA number configured to indicate the respective LBA of the uncompressed data block corresponding to the respective compressed data block.

16. The host system of claim 15, wherein the physical data block and the uncompressed data block each have a size of four kilobytes (4 KB).

17. The host system of claim 14, wherein the storage device coupled to the storage controller is selected from the group consisting of: a hard-disk drive (HDD); a solid-state disk (SSD); an embedded multimedia card (eMMC); a universal flash storage (UFS); and a universal serial bus (USB) device.

18. The host system of claim 14 integrated into an integrated circuit (IC).

19. The host system of claim 14 integrated into a device selected from the group consisting of: a set top box; an entertainment unit; a navigation device; a communications device; a fixed location data unit; a mobile location data unit; a mobile phone; a cellular phone; a smart phone; a tablet; a phablet; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

20. A method for reading data from a storage device under a hardware-accelerated compression system, comprising:
providing a read request to read one or more uncompressed data blocks from a storage device; and
for each uncompressed data block among the one or more uncompressed data blocks:
providing a respective modified logical block address (LBA) that correlates the uncompressed data block with a respective compressed data block in the storage device;
retrieving the respective compressed data block from the storage device based on the respective modified LBA; and
decompressing the respective compressed data block into the uncompressed data block.
